(19) United States
(12) Patent Application Publication
(10) Pub. No.: US 2019/0115021 A1
(43) Pub. Date: Apr. 18, 2019

(54) CONTROL AND MODIFICATION OF LANGUAGE SYSTEM OUTPUT

(71) Applicants: Claudia J. OCHOA, Sevilla (ES); Intel Corporation, Santa Clara, CA (US)

(72) Inventors: Martin Henk Van Den Berg, Palo Alto, CA (US); Claudio Ochoa, Sevilla (ES); Jose Gabriel De Amores Carredano, Sevilla, SE (ES); Beth Ann Hockey, Sunnyvale, CA (US); Robert James Firby, San Mateo, CA (US)

(73) Assignee: Intel Corporation, Santa Clara, CA (US)

(21) Appl. No.: 16/089,897

(22) PCT Filed: Apr. 1, 2016
(86) PCT No.: PCT/EP2016/057291

§ 371 Date: Sep. 28, 2018

(51) Int. Cl. G10L 15/22

(52) U.S. Cl. CPC G10L 15/22; G10L 2015/223

(57) ABSTRACT

Particular embodiments described herein provide for an electronic device that can be configured to communicate information to a user using a first style of communication, receive language-based communication from the user, and determine that the language-based communication indicates a desire of the user to change from the first style of communication to a second style of communication.

### TECHNICAL FIELD

This disclosure relates in general to the field network communication, and more particularly, to the control and modification of a communication system.

### BACKGROUND

Different users like an interactive dialog system to behave in different ways and differently at different times. For example, a user may want the system to be more or less verbose, have different choices of words, or have a different frequency in system side dialog initiation. What is needed is to make the user interaction selectable through the dialog system proper, rather than through offline preference settings or loading new behavior from vendor websites.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a portion of a communication system for the control and modification of the communication system in accordance with an embodiment of the present disclosure;

FIG. 2 is a simplified block diagram of a portion of a portion of a communication system for the control and modification of the communication system in accordance with an embodiment of the present disclosure;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a block diagram illustrating an example computing system that is arranged in a point-to-point configuration in accordance with an embodiment;

FIG. 6 is a simplified block diagram associated with an example ARM ecosystem system on chip (SOC) of the present disclosure; and

FIG. 7 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

The following detailed description sets forth example embodiments of apparatuses, methods, and systems relating to a communication system for device naming through dialog. Features such as structure(s), function(s), and/or characteristic(s), for example, are described with reference to one embodiment as a matter of convenience; various embodiments may be implemented with any suitable one or more of the described features.

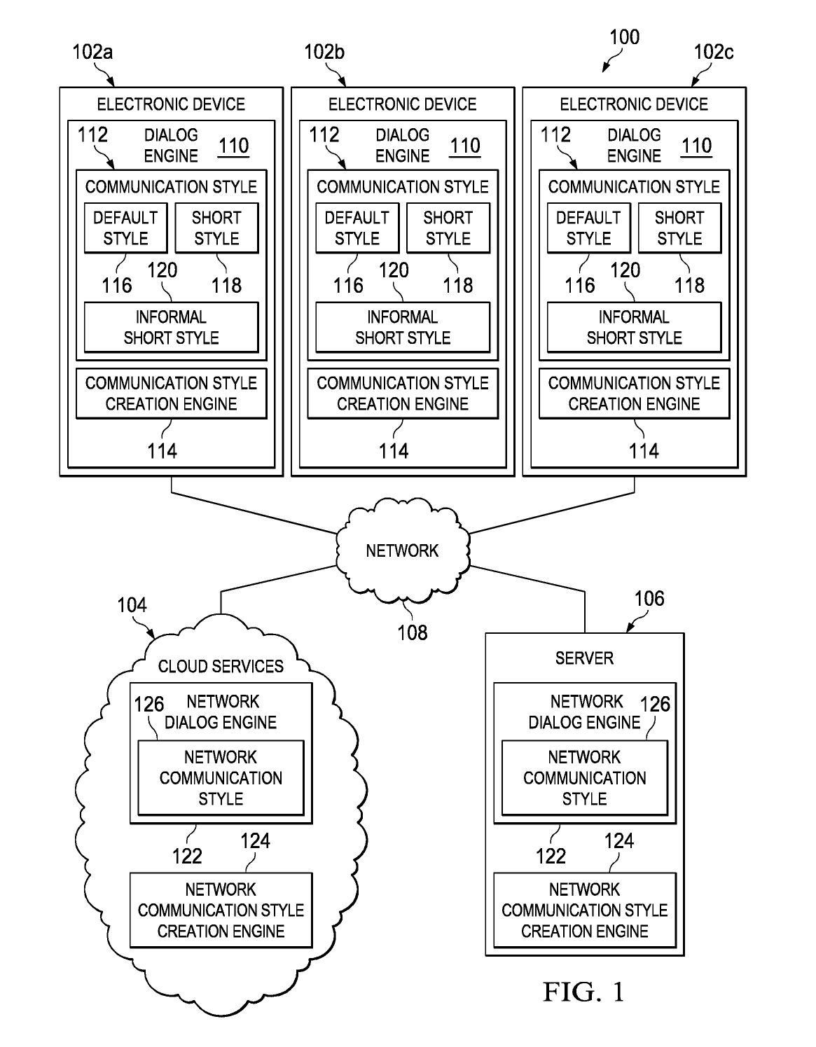

FIG. 1 is a simplified block diagram of a communication system 100 for the control and modification of a communication system in accordance with an embodiment of the present disclosure. Communication system 100 can include one or more electronic devices 102a-102c, cloud services 104, and a server 106. Electronic devices 102a-102c, cloud services 104, and server 106 can communicate with each other using network 108.

Each electronic device 102a-102c can include a dialog engine 110. Dialog engine 110 can include a communication style 112 and a communication style creation engine 114. Communication style 112 can include a default style 116, a short style 118, and an informal style 120. In other embodiments, communication style 112 can include other styles such as slang, long style, old country English, one or more languages other than English, etc. In an example, communication style creation engine 114 can be configured to modify a communication style located in communication style 112. In another example, communication style creation engine 114 can be configured to create a new type of communication style.

Cloud services 104 and server 106 can each include a network dialog engine 122 and a network communication style engine 124. Network dialog engine 122 can include a network communication style 126. Network communication style 126 can be configured to store various communication styles. For example, network communication style 126 can include communication styles that are in communication system 112 and some communication styles that are not included in communication style 112.

In an example, network communication style creation engine 124 can be configured to modify a communication style located in communication style 112 or in network communication style 126. In another example, network communication style creation engine 124 can be configured to create a new type of communication style. In one instance, a new type of communication style created or modified by network communication style creation engine 124 can be communicated to communication style 112 and network communication style 126

Elements of FIG. 1 may be coupled to one another through one or more interfaces employing any suitable connections (wired or wireless), which provide viable pathways for network (e.g., network 108) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

End users have more communications choices than ever before. A number of prominent technological trends are currently afoot (e.g., more computing devices, more connected devices, etc.). One current trend is expanding automation where smart systems replace humans in daily operations. In many cases these systems are designed to interact with a user using a dialog system. A dialog system or conversational agent (CA) is a system intended to converse with a human, with a coherent structure. Dialog systems have employed text, speech, graphics, haptics, gestures and other modes for communication.

Current solutions include an interaction style that is either fixed or, more rarely, can be changed by changing preferences on some preferences page or through loading different “packs”. What is needed is a system and method to change behavior directly through a request by a user through the dialog system itself. For example, it would be beneficial if the user could change the interaction style based on a request as expressed by the user through a dialog with the system.

A communication system for control and modification of a communication system, as outlined in FIG. 1, can resolve these issues (and others). Communication system 100 can be configured to change the interaction style of a dialog system directly through request by the user through the dialog system itself or at the request of the user as expressed through a dialog with the user. When the user asks for less wordiness, the system can adjust itself to do just that and change the dialog to a less wordy dialog. In an example, different possible utterances by the system are marked up by urgency, domain, familiarity, wordiness, and other parameters. A dialog system or dialog engine (e.g., dialog engine 110) can be configured to moderate which of the utterances are to be suppressed, or, in case there is a choice between variants, which utterance style is to be chosen (e.g., default style 116 is selected over short style 118).

In an illustrative example, a user can explicitly ask for more or less wordy explanations. In another illustrative example, the user may keep interrupting the system and the system may learn from to interruptions to not say so much or be less wordy. Also, in yet another illustrative example, the user can express frustration about not getting enough information and the system may start giving more detail. Further, in another illustrative example, the user may use certain words in favor of other system default words and the system may start using those words instead of the system default words. For example, if a user says “I 20” instead of the default “Interstate 20,” then the system may use the portion of a phrase “I 20” instead of the phrase “Interstate 20.”

Communication style creation engine 114 or network communication style creation engine 124 may monitor dialog with the user and recognize any deviations in terms, words, or phrases for a notion. More specifically, if the user keeps using a different term, word, or phrase for a notion, the system may decide to echo the different term, word or phrase. Alternatively, the system may insistent on using the “correct” term in such cases to educate the user, even if the system can understand the user when the “wrong” or “incorrect” term is used. For example, if a Highway 42 is renamed to Martin Luther King Highway but the user still calls the highway Highway 42, the system may not echo the wrong term and call the highway by the correct name or term. Although the above example is of a direction giving system, it can be applied to a variety of different situations where the system has multiple ways of expressing information to a user including, but not limited to fitness and health applications, home automation or shopping assistants, etc. Also, the system is not limited to an English language based system and the system may use almost any other language. In addition, Numerous different possible communication styles can be explicitly or implicitly coded up in the system and the above are only an example of a few of the possible communication styles.

Turning to the infrastructure of FIG. 1, communication system 100 in accordance with an example embodiment is shown. Generally, communication system 100 can be implemented in any type or topology of networks. Network 108 represents a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals (analog, digital or any combination of the two), data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications (e.g., over a cellular network) may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic devices 102a-102c, cloud services 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic devices 102a-102c, cloud services 104, and server 106 can include memory elements for storing information to be used in the operations outlined herein. Each of electronic devices 102a-102c, cloud services 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), non-volatile memory (NVRAM), magnetic storage, magneto-optical storage, flash storage (SSD), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic devices 102a-102c, cloud services 104, and server 106 may include software modules (e.g., dialog engine 110, communication style creation engine 114, network dialog engine 122, network communication style creation engine 124, etc.) to achieve, or to foster, operations as outlined herein. These modules may be suitably combined in any appropriate manner, which may be based on particular configuration and/or provisioning needs. In some embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic devices 102a-102c, cloud services 104, and server 106 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Each of electronic devices 102a-102c can be a network element and includes, for example, desktop computers, laptop computers, mobile devices, personal digital assistants, smartphones, tablets, wearables, or other similar devices. Cloud services 104 is configured to provide cloud services to electronic devices 102a-102c. Cloud services 104 may generally be defined as the use of computing resources that are delivered as a service over a network, such as the Internet. The services may be distributed and separated to provide required support for electronic devices 102a-102c and cloud services 104. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication system 100. Although dialog engine 110 and communication style creation engine 114 are represented in FIG. 1 as being located in network controller 104 and network dialog engine 122 and network communication style creation engine 124 are represented in FIG. 1 as being located in cloud services 104 and server 106, this is for illustrative purposes only. Dialog engine 110, communication style creation engine 114, network dialog engine 122, and network communication style creation engine 124 could be combined or separated in any suitable configuration. Furthermore, dialog engine 110, communication style creation engine 114, network dialog engine 122, and network communication style creation engine 124 could be integrated with or distributed in another network accessible by one or more of electronic devices 102a-102c.

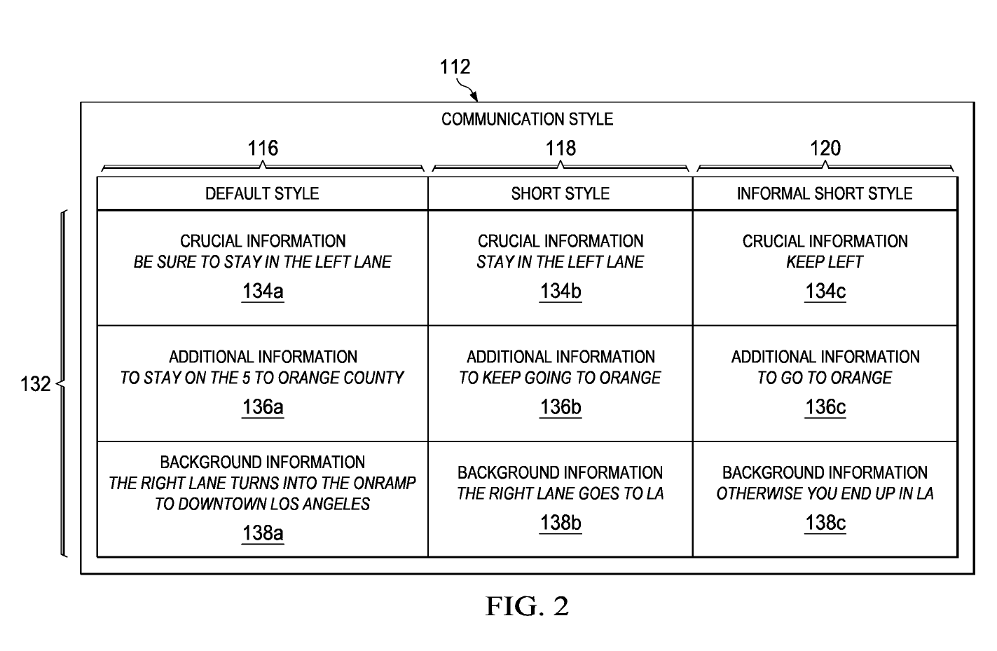

Turning to FIG. 2, FIG. 2 is a simplified block diagram of a portion of communication system 100 for the control and modification of a communication system in accordance with an embodiment of the present disclosure. As illustrated in FIG. 2, communication style 112 can include default style 116, short style 118, and informal short style 120. Default style 116, short style 118, and informal short style 120 can each include one or more types of information 132. For example, default style 116 can include crucial information 134a, additional information 136a, and background information 138a, short style 118 can include crucial information 134b, additional information 136b, and background information 138b, and informal short style 120 can include crucial information 134c, additional information 136c, and background information 138c.

In an example, if default style 116 is currently being used by dialog engine 110 and a comment or communication for less detail is received from a user, dialog engine 110 can change the style to short style 118, informal short style 120, or some other style that will provide less detail. Also, if the system (e.g., communication style creation engine 114) determines that a user never says Los Angeles but instead says LA, background information 138a of default style 116 can change the term “Los Angeles” to “LA.” Each type of information 132 (e.g., crucial information 134a, additional information 136a, and background information 138a for default style 116, crucial information 134b, additional information 136b, and background information 138b for short style 118, and crucial information 134c, additional information 136c, and background information 138c for informal short style 120) can be changed or modified to accommodate a request style by the user or an inferred style that the user would prefer. For example, an inferred style can be a communication style that dialog engine 110 has determined, through indirect means and not a direct or specific request, the user would prefer. More specifically, if a user said “more information” or “I need more info” several times during a communication session or within a certain period of time, then dialog engine 110 can infer that the user would like the communication style to be changed from informal short style to short style or to a wordier default style.

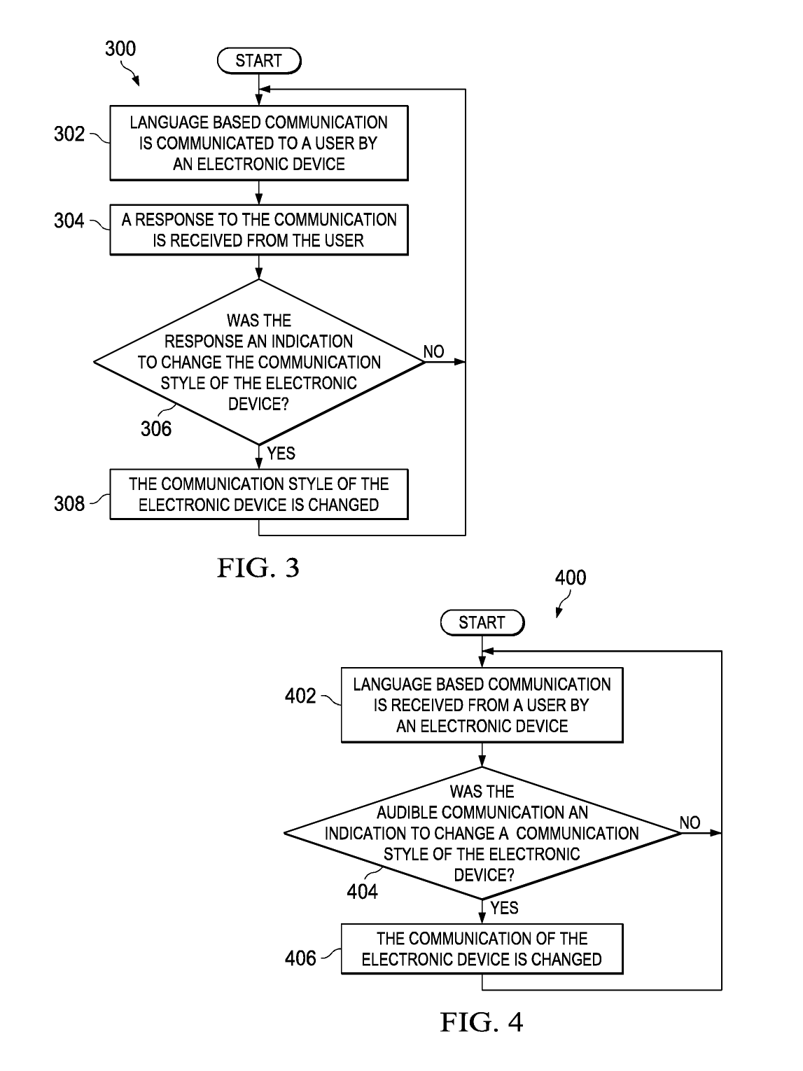

Turning to FIG. 3, FIG. 3 is an example flowchart illustrating possible operations of a flow 300 that may be associated with control and modification of a communication system, in accordance with an embodiment. In an embodiment, one or more operations of flow 300 may be performed by dialog engine 110, communication style creation engine 114, network dialog engine 122, and network communication style creation engine 124. At 302, language-based communication is communicated to a user by an electronic device. At 304, a response to the communication is received from the user. At 306, the system determines if the response was an indication to change the communication style of the electronic device. For example, communication style 112 or communication style creation engine 114 can determine if the response was an indication to change the communication style of the electronic device 102a. If the response was an indication to change the communication style of the electronic device, then the communication style of the electronic device is changed, as in 308 and the system returns to 302 and language-based communication (using the new communication style) is communicated to the user by the electronic device. For example, based on an indication (either direct or inferred) to change the the communication style of electronic device 102a, the communication style may change from default style 116 to short style 118, from short style 118 to informal short style 120, from informal short style 120 to default style, etc. If the response was not an indication to change the communication style of the electronic device, then the system returns to 302 and language-based communication is communicated to the user by the electronic device.

Turning to FIG. 4, FIG. 4 is an example flowchart illustrating possible operations of a flow 400 that may be associated with control and modification of a communication system, in accordance with an embodiment. In an embodiment, one or more operations of flow 400 may be performed by dialog engine 110, communication style creation engine 114, network dialog engine 122, and network communication style creation engine 124. At 402, language-based communication is received from a user by an electronic device. At 404, the system determines if the language-based communication was an indication to change a communication style of the electronic device. If the language-based communication was an indication (either direct or inferred) to change a communication style of the electronic device, then the communication of the electronic device is changed as in 406 and the system returns to 402. If the language-based communication was not an indication to change a communication style of the electronic device, then the system returns to 402.

For example, dialog engine 110, communication style creation engine 114, network dialog engine 122, or network communication style creation engine 124a may determine (either directly or by inference) that a user has asked for a wordier explanation or that the user has expressed frustration about not getting enough information and the system may start giving more detail. In that example, dialog engine 110, communication style creation engine 114, network dialog engine 122, network communication style creation engine 124 can change the dialog from informal short style 120 to short style 118 or from short style 118 to default style. In another example, dialog engine 110, communication style creation engine 114, network dialog engine 122, or network communication style creation engine 124a may determine that a user has asked for a less wordy or shorter explanation or that the user may keep interrupting the system and the system learns from to interruptions to not say so much. In that example, dialog engine 110, communication style creation engine 114, network dialog engine 122, network communication style creation engine 124 can change the dialog from short style 118 to informal short style 120 or from default style to short style 118. In yet another example. dialog engine 110, communication style creation engine 114, network dialog engine 122, or network communication style creation engine 124a may determine (either directly or by inference) (either directly or by inference) that the user prefers certain words in favor of others, and the system may start using those words instead of default words. Communication style creation engine 114 and network communication style creation engine 124 can modify an existing style to include a user preferred word or phrase or may create a new commination style.

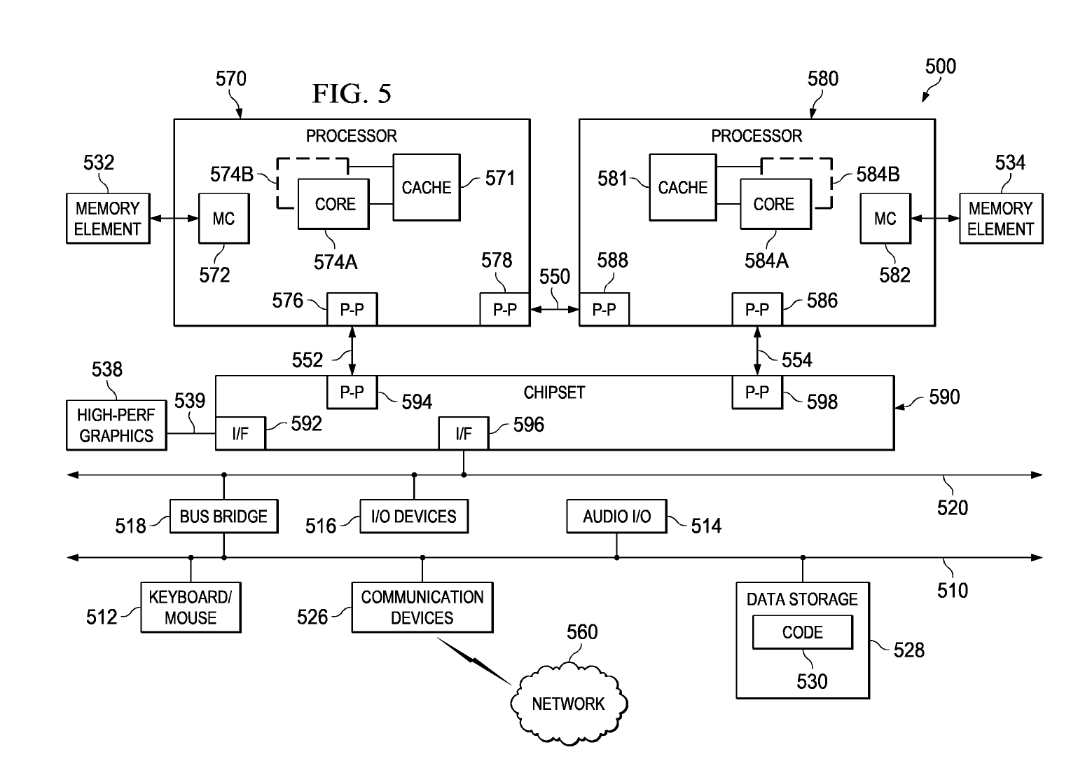

Turning to FIG. 5, FIG. 5 illustrates a computing system 500 that is arranged in a point-to-point (PtP) configuration according to an embodiment. In particular, FIG. 5 shows a system where processors, memory, and input/output devices are interconnected by a number of point-to-point interfaces. Generally, one or more of the network elements of communication system 100 may be configured in the same or similar manner as computing system 500.

As illustrated in FIG. 5, system 500 may include several processors, of which only two, processors 570 and 580, are shown for clarity. While two processors 570 and 580 are shown, it is to be understood that an embodiment of system 500 may also include only one such processor. Processors 570 and 580 may each include a set of cores (i.e., processor cores 574A and 574B and processor cores 584A and 584B) to execute multiple threads of a program. The cores may be configured to execute instruction code in a manner similar to that discussed above with reference to FIGS. 3 and 4. Each processor 570, 580 may include at least one shared cache 571, 581. Shared caches 571, 581 may store data (e.g., instructions) that are utilized by one or more components of processors 570, 580, such as processor cores 574 and 584.

Processors 570 and 580 may also each include integrated memory controller logic (MC) 572 and 582 to communicate with memory elements 532 and 534. Memory elements 532 and/or 534 may store various data used by processors 570 and 580. In alternative embodiments, memory controller logic 572 and 582 may be discrete logic separate from processors 570 and 580.

Processors 570 and 580 may be any type of processor, and may exchange data via a point-to-point (PtP) interface 550 using point-to-point interface circuits 578 and 588, respectively. Processors 570 and 580 may each exchange data with a control logic 590 via individual point-to-point interfaces 552 and 554 using point-to-point interface circuits 576, 586, 594, and 598. Control logic 590 may also exchange data with a high-performance graphics circuit 538 via a high-performance graphics interface 539, using an interface circuit 592, which could be a PtP interface circuit. In alternative embodiments, any or all of the PtP links illustrated in FIG. 5 could be implemented as a multi-drop bus rather than a PtP link.

Control logic 590 may be in communication with a bus 520 via an interface circuit 596. Bus 520 may have one or more devices that communicate over it, such as a bus bridge 518 and I/O devices 516. Via a bus 510, bus bridge 518 may be in communication with other devices such as a keyboard/mouse 512 (or other input devices such as a touch screen, trackball, etc.), communication devices 526 (such as modems, network interface devices, or other types of communication devices that may communicate through a computer network 560), audio I/O devices 514, and/or a data storage device 528. Data storage device 528 may store code 530, which may be executed by processors 570 and/or 580. In alternative embodiments, any portions of the bus architectures could be implemented with one or more PtP links.

The computer system depicted in FIG. 5 is a schematic illustration of an embodiment of a computing system that may be utilized to implement various embodiments discussed herein. It will be appreciated that various components of the system depicted in FIG. 5 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, internet-of-things devices, constrained devices (sensors, actuators, controllers), appliances, small wearables, health and quantified-self devices, industrial, devices, etc. It will be appreciated that these mobile devices may be provided with SoC architectures in at least some embodiments.

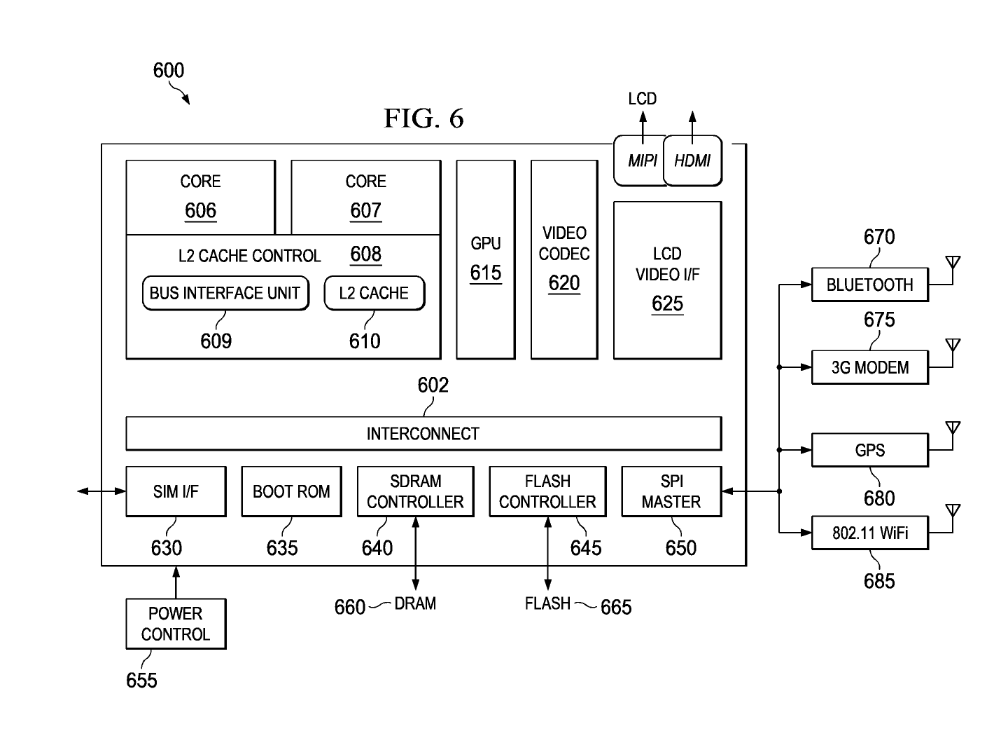

Turning to FIG. 6, FIG. 6 is a simplified block diagram associated with an example SOC 600 of the present disclosure. At least one example implementation of the present disclosure can include the protected data collection features discussed herein. For example, the architecture can be part of any type of tablet, smartphone (inclusive of Android™ phones, iPhones™, iPad™ Google Nexus™, Microsoft Surface™, personal computer, server, video processing components, laptop computer (inclusive of any type of notebook), Ultrabook™ system, any type of touch-enabled input device, etc.

In this example of FIG. 6, SOC 600 may include multiple cores 606-607, an L2 cache control 608, a bus interface unit 609, an L2 cache 610, a graphics processing unit (GPU) 615, an interconnect 602, a video codec 620, and a liquid crystal display (LCD) I/F 625, which may be associated with mobile industry processor interface (MIPI)/high-definition multimedia interface (HDMI) links that couple to an LCD.

SOC 600 may also include a subscriber identity module (SIM) I/F 630, a boot read-only memory (ROM) 635, a synchronous dynamic random access memory (SDRAM) controller 640, a flash controller 645, a serial peripheral interface (SPI) master 650, a suitable power control 655, a dynamic RAM (DRAM) 660, and flash 665. In addition, one or more embodiments include one or more communication capabilities, interfaces, and features such as instances of Bluetooth™ 670, a 3G modem 675, a global positioning system (GPS) 680, and an 802.11 Wi-Fi 685.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe™ Flash™ Player, Java Platform Standard Edition (Java SE), JavaFX, Linux, Microsoft Windows Embedded, Symbian and Ubuntu, etc.). In at least one embodiment, the core processor may implement an out-of-order superscalar pipeline with a coupled low-latency level-2 cache.

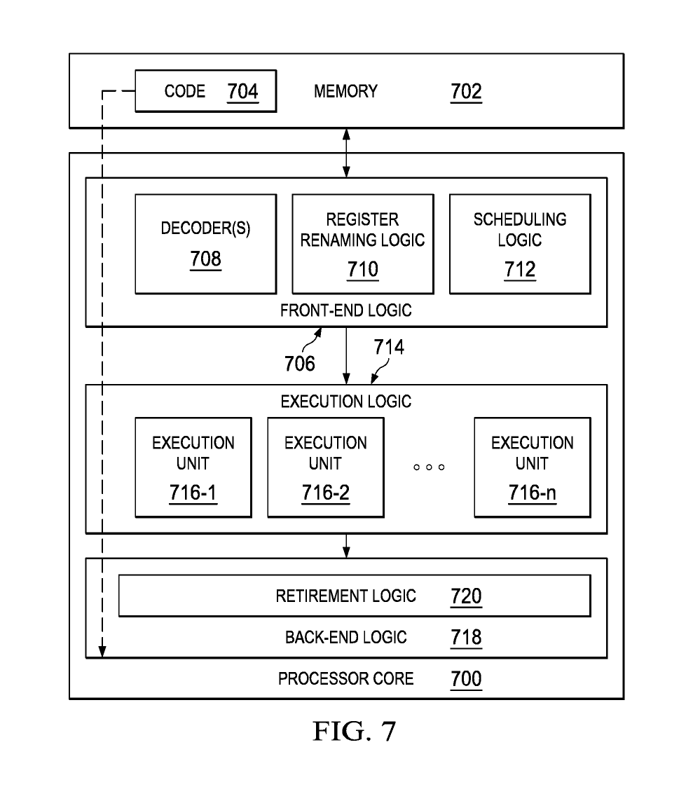

FIG. 7 illustrates a processor core 700 according to an embodiment. Processor core 7 may be the core for any type of processor, such as a micro-processor, an embedded processor, a digital signal processor (DSP), a network processor, or other device to execute code. Although only one processor core 700 is illustrated in FIG. 7, a processor may alternatively include more than one of the processor core 700 illustrated in FIG. 7. For example, processor core 700 represents an embodiment of processors cores 574a, 574b, 584a, and 784b shown and described with reference to processors 570 and 580 of FIG. 5. Processor core 700 may be a single-threaded core or, for at least one embodiment, processor core 700 may be multithreaded in that it may include more than one hardware thread context (or “logical processor”) per core.

FIG. 7 also illustrates a memory 702 coupled to processor core 700 in accordance with an embodiment. Memory 702 may be any of a wide variety of memories (including various layers of memory hierarchy) as are known or otherwise available to those of skill in the art. Memory 702 may include code 704, which may be one or more instructions, to be executed by processor core 700. Processor core 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor core 700 can also include execution logic 714 having a set of execution units 716-1 through 716-N. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor core 700 allows out of order execution but requires in order retirement of instructions. Retirement logic 720 may take a variety of known forms (e.g., re-order buffers or the like). In this manner, processor core 700 is transformed during execution of code 704, at least in terms of the output generated by the decoder, hardware registers and tables utilized by register renaming logic 710, and any registers (not shown) modified by execution logic 714.

Although not illustrated in FIG. 7, a processor may include other elements on a chip with processor core 700, at least some of which were shown and described herein with reference to FIG. 5. For example, as shown in FIG. 5, a processor may include memory control logic along with processor core 700. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and their teachings are readily scalable and can accommodate a large number of components, as well as more complicated/sophisticated arrangements and configurations. Accordingly, the examples provided should not limit the scope or inhibit the broad teachings of communication system 100 and as potentially applied to a myriad of other architectures.

It is also important to note that the operations in the preceding flow diagrams (i.e., FIGS. 3 and 4) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable medium having one or more instructions that when executed by at least one processor cause the at least one processor to communicate information to a user using a first style of communication, receive language-based communication from the user, and determine that the language-based communication indicates a desire of the user to change from the first style of communication to a second style of communication.

In Example C2, the subject matter of Example C1 can optionally include where the first communication style is a default style and the second communication style is a short style.

In Example C3, the subject matter of any one of Examples C1-C2 can optionally include where the change in communication style includes changing a word or phrase to match a user's preference for the word or phrase.

In Example C4, the subject matter of any one of Examples C1-C3 can optionally include where where the instructions, when executed by the at least one processor, further cause the at least one processor to determine that the user prefers a different word or phrase and not change the commination style to include the preferred different word or phrase.

In Example C5, the subject matter of any one of Examples C1-C4 can optionally include where the first commination style includes a plurality of portions and only one portion of the communication style is changed.

In Example C6, the subject matter of any one of Examples C1-05 can optionally include where the user specifically asks for the communication style to be changed from the first style of communication to the second style of communication.

In Example C7, the subject matter of any one of Example C1-C6 can optionally include where the system infers that the language-based communication indicates the desire of the user to change from the first style of communication to a second style of communication.

In Example A1, an apparatus can include a dialog module, where the dialog module is configured to communicate information to a user using a first style of communication, receive language-based communication from the user, and determine that the language-based communication indicates a desire of the user to change from the first style of communication to a second style of communication.

In Example, A2, the subject matter of Example A1 can optionally include where the first communication style is a default style and the second communication style is a short style.

In Example A3, the subject matter of any one of Examples A1-A2 can optionally include where the change in communication style includes changing a word or phrase to match a user's preference for the word or phrase.

In Example A4, the subject matter of any one of Examples A1-A3 can optionally include where where the dialog module is further configured to determine that the user prefers a different word or phrase, and not change the commination style to include the preferred different word or phrase.

In Example A5, the subject matter of any one of Examples A1-A4 can optionally include where the first commination style includes a plurality of portions and only one portion of the communication style is changed.

In Example A6, the subject matter of any one of Examples A1-A5 can optionally include where the user specifically asks for the communication style to be changed from the first style of communication to the second style of communication.

In Example A7, the subject matter of any one of Examples A1-A6 can optionally include where the system infers that the language-based communication indicates the desire of the user to change from the first style of communication to a second style of communication.

Example M1 is a method including communicating information to a user using a first style of communication, receiving language-based communication from the user, and determining that the language-based communication indicates a desire of the user to change from the first style of communication to a second style of communication.

In Example M2, the subject matter of Example M1 can optionally include where the first communication style is a default style and the second communication style is a short style.

In Example M3, the subject matter of any one of the Examples M1-M2 can optionally include where the change in communication style includes changing a word or phrase to match a user's preference for the word or phrase.

In Example M4, the subject matter of any one of the Examples M1-M3 can optionally include where the first commination style includes a plurality of portions and only one portion of the communication style is changed.

In Example M5, the subject matter of any one of the Examples M1-M4 can optionally include where the user specifically asks for the communication style to be changed from the first style of communication to the second style of communication.

In Example M6, the subject matter of any one of the Examples M1-M5 can optionally include where the system infers that the language-based communication indicates the desire of the user to change from the first style of communication to a second style of communication.

In Example AA1, an apparatus can include means for communicating information to a user using a first style of communication, means for receiving language-based communication from the user, and means for determining that the language-based communication indicates a desire of the user to change from the first style of communication to a second style of communication.

In Example, AA2, the subject matter of Example AA1 can optionally include where the first communication style is a default style and the second communication style is a short style.

In Example AA3, the subject matter of any one of Examples AA1-AA2 can optionally include where the change in communication style includes changing a word or phrase to match a user's preference for the word or phrase.

In Example AA4, the subject matter of any one of Examples AA1-AA3 can optionally include where the first commination style includes a plurality of portions and only one portion of the communication style is changed.

In Example AA5, the subject matter of any one of Examples AA1-AA4 can optionally include where the user specifically asks for the communication style to be changed from the first style of communication to the second style of communication.

In Example AA6, the subject matter of any one of Examples AA1-AA5 can optionally include where the system infers that the language-based communication indicates the desire of the user to change from the first style of communication to a second style of communication.

In Example AA7, the subject matter of any one of Examples AA1-AA6 can optionally include means for determining that the user prefers a different word or phrase and means for not changing the commination style to include the preferred different word or phrase.

Example S1 is a system for the control and modification of a communication system, the system including a dialog engine, where the dialog engine is configured to communicate information to a user using a first style of communication, receive language-based communication from the user, and determine that the language-based communication indicates a desire of the user to change from the first style of communication to a second style of communication.

In Example S2, the subject matter of Example S1 can optionally include where the first communication style is a default style and the second communication style is a short style.

In Example S3, the subject matter of any of the Examples S1-S2 can optionally include where the change in communication style includes changing a word or phrase to match a user's preference for the word or phrase.

Example X1 is a machine-readable storage medium including machine-readable instructions to implement a method or realize an apparatus as in any one of the Examples A1-A7, or M1-M7. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

1. At least one machine readable medium comprising one or more instructions that when executed by at least one processor, cause the at least one processor to:
communicate information to a user using a first style of communication;
receive language-based communication from the user; and
determine that the language-based communication indicates a desire of the user to change from the first style of communication to a second style of communication.

2. The at least one machine readable medium of claim 1, wherein the first communication style is a default style and the second communication style is a short style.

3. The at least one machine readable medium of claim 1, wherein the change in communication style includes changing a word or phrase to match a user's preference for the word or phrase.

4. The at least one machine readable medium of claim 3, further comprising one or more instructions that when executed by the at least one processor, cause the at least one processor to:
determine that the user prefers a different word or phrase; and
not change the commination style to include the preferred different word or phrase.

5. The at least one machine readable medium of claim 1, wherein the first commination style includes a plurality of portions and only one portion of the communication style is changed.

6. The at least one machine readable medium of claim 1, wherein the system infers that the language-based communication indicates the desire of the user to change from the first style of communication to the second style of communication.

7. The at least one computer-readable medium of claim 1, wherein the language-based communication is an audible communication.

8. An apparatus comprising:
memory;
a processor; and
a dialog module, wherein the dialog module is configured to:
communicate information to a user using a first style of communication;
receive language-based communication from the user; and
determine that the language-based communication indicates a desire of the user to change from the first style of communication to a second style of communication.

9. The apparatus of claim 8, wherein the first communication style is a default style and the second communication style is a short style.

10. The apparatus of claim 8, wherein the change in communication style includes changing a word or phrase to match a user's preference for the word or phrase.

11. The apparatus of claim 10, wherein the dialog module is further configured to:
determine that the user prefers a different word or phrase; and
not change the commination style to include the preferred different word or phrase.

12. The apparatus of claim 8, wherein the first commination style includes a plurality of portions and only one portion of the communication style is changed.

13. The apparatus of claim 8, wherein the user specifically asks for the communication style to be changed from the first style of communication to the second style of communication.

14. The apparatus of claim 8, wherein the language-based communication is an audible communication.

15. A method comprising:
communicating information to a user using a first style of communication;
receiving language-based communication from the user; and
determining that the language-based communication indicates a desire of the user to change from the first style of communication to a second style of communication.

16. The method of claim 15, wherein the first communication style is a default style and the second communication style is a short style.

17. The method of claim 15, wherein the change in communication style includes changing a word or phrase to match a user's preference for the word or phrase.

18. The method of claim 17, wherein the first commination style includes a plurality of portions and only one portion of the communication style is changed.

19. The method of claim 15, wherein the system infers that the language-based communication indicates the desire of the user to change from the first style of communication to the second style of communication.

20. The method of claim 15, wherein the language-based communication is audible communication.
